(19) United States
(12) Patent Application Publication
(10) Pub. No.: US 2010/0293027 A1
(43) Pub. Date: Nov. 18, 2010

(54) WORKFLOW ENGINE FOR MEDIA PRODUCTION AND DISTRIBUTION

(76) Inventor: Eric Denis Du Fosse, Portland, OR (US)

Correspondence Address: Robert D. Shedd, Patent Operations;THOMSON Licensing LLC, P.O. Box 5312, Princeton, NJ, 08543-5312, US

(21) Appl. No.: 12/450,173

(22) PCT Filed: Apr. 8, 2008
(86) PCT No.: PCT/US08/04535

§ 371 Date: Sep. 14, 2009

Related U.S. Application Data
(60) Provisional application No. 60/923,011, filed on Apr. 12, 2007.

(51) Int. Cl. G06Q 10/00; G06Q 90/00

(52) U.S. Cl. 705/9; 705/500

(57) ABSTRACT

A Workflow Engine comprises part of Workflow Management system and serves to automatically forward Work Orders as specific Tasks to specific Workplaces based on defined Workflows. Both the Work order and the Workflow are aggregated into a Work Package Template created by using a graphical Work package Editor based on requirements as outcome of a workflow analysis. Multiple Work Package Templates can be managed in parallel, allowing coping with the different needs in the different areas of a broadcast facility.

### CROSS-REFERENCE TO RELATED APPLICATIONS

This application claims priority under 35 U.S.C. 119(e) to U.S. Provisional Patent Application Ser. No. 60/923,011, filed 12 Apr. 2007, the teachings of which are incorporated herein.

### TECHNICAL FIELD

The present concepts relate to a system for managing content. More particularly, they relate to a workflow management system in a media production environment.

### BACKGROUND ART

Today, the link between business systems and the broadcast world is mainly through Broadcast Automation Systems which manage the frame accurate playout of video/audio essence (clips). The area these systems are mainly addressing is INGEST, PLAYOUT and ARCHIVE. They receive play-/record lists, perform the check in the managed subsystems (usually a file based video server and data archives via HSM) and play the right clips in the right order.

Furthermore, these systems discover missing clips and issue the transfer of clips to the appropriate subsystem a predefined time before the clip needs to be available, if the clip is available in the system. Otherwise they create a missing list of clips, and an operator then needs to manage the ingest server.

Another mechanism often used today is the automatic discovery of essence in a defined directory (folder of a file system). This function is called the watch folder functionality which is performed on the discovery of an essence a defined task like transcoding, transfer to a defined location, etc.

The above described approach and systems do not provide a means to inform certain operators at a certain workplace about a task, and a corresponding task description to perform, plus the content in the right format. There is no predefined set of work orders, workplaces and/or tasks to start different work package templates, provided from a business system, that contains a predefined number of work orders along with a defined order of workstations where the individual tasks needs to be performed. Furthermore certain conditions are not contained like, for example, providing a transfer/transcode of an essence to a certain workplace before the task appears there to be executed.

In the media industry a number of solutions have been developed or adapted to address specific needs and they are now converging to a global solution of media asset management with different levels of workflow management support:

1) Playout Automation: Control affords real time control of devices that playout video and audio content according a schedule. Several playout devices have the capability to organize the movement of content at the ingest (content receipt) and storage phases: Manufacturers of playout devices have addressed device interface issues but are still evolving to support the concept of a workflow engine. Their solutions propose static workflows that generally require significant rework at the configuration stage.
2) Manufacturers of Document Media Asset management systems have demonstrated an ability to manage documents. Many such companies have evolved into the multimedia environment to tackle the media industry. The solutions from such companies have very severe limitations in real time device resource management and offer very limited ways, if any, to manage workflow.
3) A number of companies offer video editing systems. At least one manufacturer of video editing systems now offers a non linear workflow solution for the media industry which also requires using workflow in a static way.
4) IT middleware providers have traditionally specialized on the business layer applications. In this regard, such provider have proposed an infrastructure to manage transactional layer to handle workflows. Because such providers have focused on business layers, the solutions from such providers do not provide a user interface and cannot control resources with load balancing or quality of services (QOS) constraints.

In short, content creation environment in Media industry and corresponding business layers do not provide sufficient control over work orders to enable the addition of an advertisement in relationship with a customer, on an automated, real time basis. The technical workflow associated with managing content remains extremely labor intensive and still functions with, and is organized by, silos having only a few supervisors per department that manage operations using very limited tools. The creation of media in a broadcast television facility or post production environment currently lacks an administration solution to efficiently handle content management.

### BRIEF SUMMARY OF THE PRESENT PRINCIPLES

According to one illustrative embodiment of the present principles, a method for media production and distribution includes examining a Workflow pattern to identify a task order and at least one Workplace responsible for tasks within a given order, and notifying Workplaces to perform their tasks in the given task order defined by the Workflow pattern.

The details of the illustrative embodiments are set forth in the accompanying drawings and the description below. Even if described in one particular manner, it should be clear that each illustrative embodiment can be configured or embodied in various manners. For example, an embodiment can be performed as a method, or embodied as an apparatus configured to perform a set of operations or an apparatus storing instructions for performing a set of operations. Other aspects and features will become apparent from the following detailed description considered in conjunction with the accompanying drawings and the claims.

### BRIEF DESCRIPTION OF THE DRAWINGS

FIG. 1 depicts an exemplary representation of standard Workflow pattern as part of a Work Package according to an illustrative embodiment of the present principles;

FIG. 2 depicts an exemplary representation of a split Workflow pattern as part of a Work Package according to an illustrative embodiment of the present principles;

FIG. 3 depicts an exemplary representation of another split Workflow pattern as part of a Work Package according to an illustrative embodiment of the present principles;

FIG. 4 depicts an example of a dynamic user interface task base according to an illustrative embodiment of the present principles;

FIG. 5 depicts a schematic representation of the Workflow engine according to an illustrative embodiment of the present principles;

FIG. 6 depicts an exemplary representation of the Workflow engine user interface according to an illustrative embodiment of the present principles;

FIG. 7 depicts a block schematic diagram of a Workflow engine in accordance with an illustrative embodiment of the present principles;

FIG. 8 depicts a high level diagram of the method for media production according to an illustrative embodiment of the present principles; and

FIG. 9 depicts another high level diagram of the method for media production according to an illustrative embodiment of the present principles.

### DETAILED DESCRIPTION

Briefly, in accordance with one aspect of the present principles, there is provided a Workflow Engine as part of Workflow Management system. The Workflow Engine provides means to automatically forward Work Orders as specific Tasks to specific Workplaces based on defined Workflows. Both the Work order and the Workflow are aggregated into a Work Package Template created by using a graphical Work package Editor in accordance with requirements determined from an analysis broadcast facility “real life” workflows. Multiple Work Package Templates can be managed in parallel, allowing coping with the different needs in the different areas of a broadcast facility.

The Workflow Engine of the present principles further provide means to instantiate Work Packages from previously designed Work Package Templates, which can be seen as “blue prints”, while combining actual process data for the Work Order and the Workflow together with the “blue print” or template. This can be done either with operator interaction at specific Workplaces or automatically by an external system using an appropriate interface. It is also possible to instantiate Work Packages from within an active Work Package, allowing the concatenation of Work Packages.

The Workflow Engine is designed to cope with workflow management specific “long running” tasks, while providing process and thread agility that allows total persistence of the status of the workflow for the time the workflow waits for response triggers from the process environment. The Workflow, which comprises part of a Work Package, is modeled using Activities, which represent either standard workflow patterns or Split/Join patterns. Furthermore, Activities are used to model the Work Package itself as well as Tasks as parts of the Work Package, which are concatenated to a workflow using Workflow Pattern Activities.

Task Activities are used to model the Workplaces, where Work Orders show up as Tasks according to the Workflow. “Within” Task Action Activities will be used to model the actions, which provide the actual interfaces to the process environment. “Inside” Task Action Activities can be concatenated with Workflow Pattern Activities (within the Work Package) to model the workflow at this level.

Before proceeding to describe the details of the present principles, a definition of several abbreviations will prove helpful:

Essence: video/audio
Content: video/audio plus metadata
Automation System: a system that performs the frame accurate playout of content (video, audio, graphics, logos etc.) to a predefined time and in a defined order, and includes transition templates for Vision Mixers.

### VTR: Video Tape Recorder

### HSM: Hierarchical Storage Management Systems

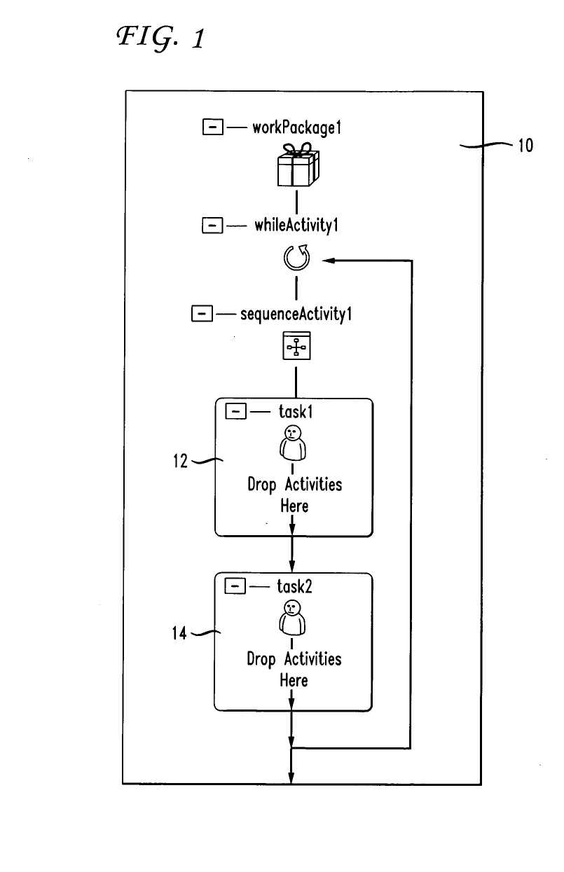

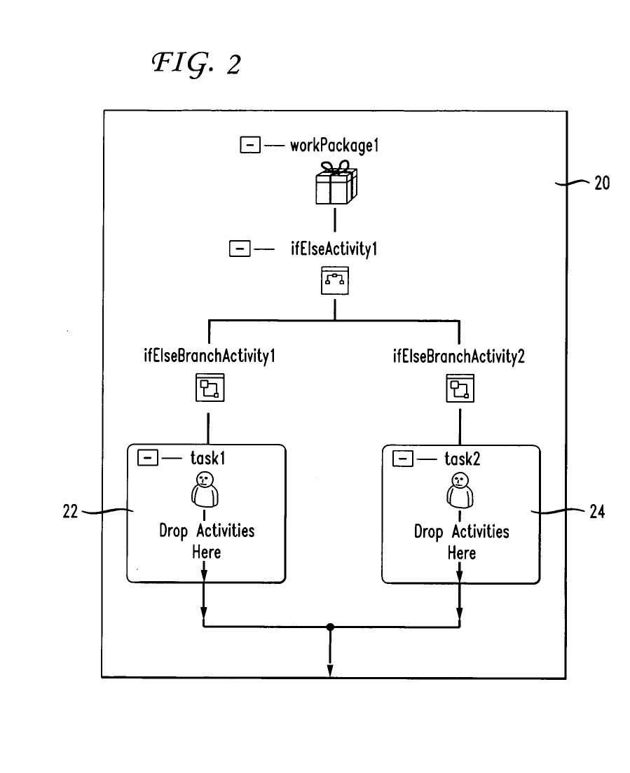

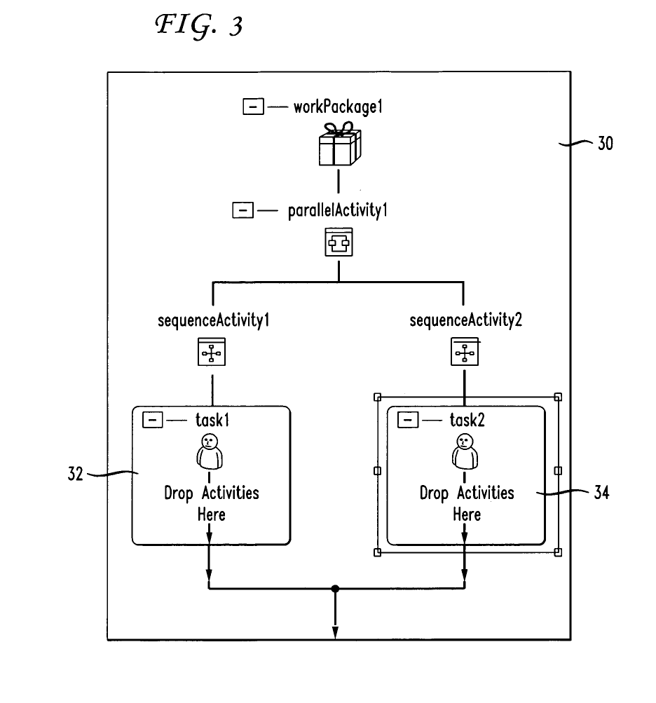

FIG. 1 shows an exemplary Work Package showing a standard workflow pattern where the task action activities 12 and 14 are in a sequence according to the Sequence Activity. FIG. 2 shows an example of a Work Package 20 showing a split workflow pattern, where the task action activities 22 and 24 are split based on an alternative workflow path identified as“if ElseActivity”. Here, each task action activity 22 and 24 comprises part of its respective if ElseActivity1 and if ElsActivity2 branch of the workflow, and is performed based on the conditions set by the if ElseActivity. FIG. 3 shows an example of a Work Package 30 showing a split workflow pattern, where the task action activities 32 and 34 are split on a parallel activity workflow. Here, each task 32 and 34 is performed in parallel with each other based on the respective sequenceActivity1 and sequenceActivity2. The Workflow Engine comes with a bundle of broadcast domain-specific Action Activities allowing control of process devices of subsystems either using an underlying Content Management System or by controlling the devices of sub-systems directly.

Depending on the Action Activities used in a Task, it can be either executed automatically or manually. For example, if only Process Control Action Activities are used, the Task can be completely automatically executed. If a User Interface Action Activity is used, the Task will require manual execution.

Manual Tasks appear at defined User Workplaces, where operators do their work, which is defined in the Work Order for a specific Workplace.

Automatic Tasks appear at “Automatic Workplaces”, where the status and the progress of automatically executed process control actions will be displayed.

The Workflow Engine provides means to control the run-down of the Work Orders as part of an active Work Package and to obtain status information about the Workflow Engine and the controlled Work Packages within the Workflow Engine. The content management technique of the present principles provides:
A Dynamic user interface task base that enables each user to know what is required of them and to provide each user a description of the task; and identifies the resource required to execute the task.

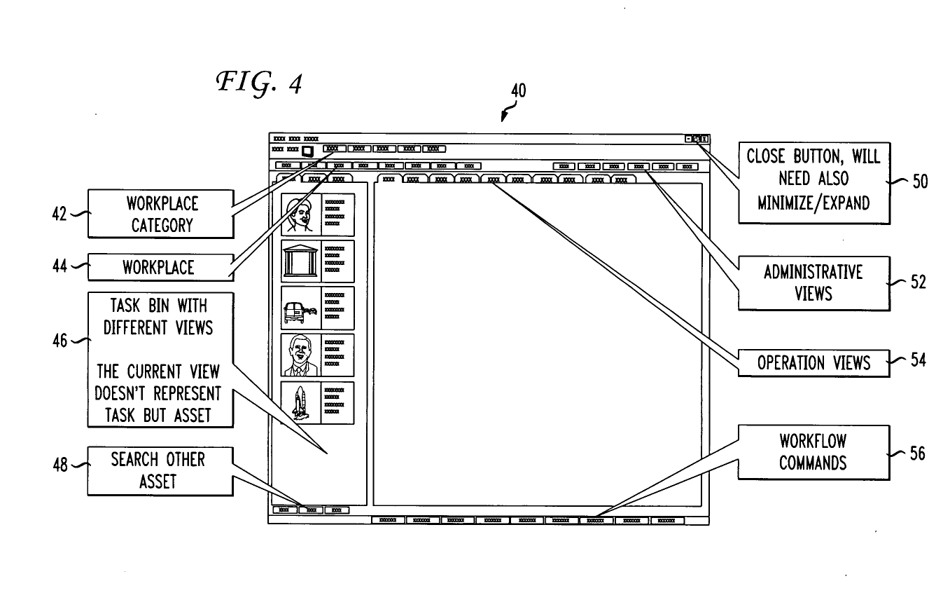

FIG. 4 shows an example of the dynamic user interface 40 according to an illustrative embodiment of the present principles. The close button 50 is commonplace for this type of window, but is shown to demonstrate the “window” aspect of this interface. The user interface 40 provides the user with straightforward and simple access to the workplace category 42, the workplace 44, and the Task bin 46 with various views. The user also has the ability to search other assets 48, along with administrative views 52, operation views 54, and an identification of the workflow commands 56. These various views and operations are all provided in a dynamic environment that allows user operation and control not currently available in the media production/distribution environment;
A framework that helps to define, manage and monitor operations as well as managing the infrastructure;
An advanced Media Asset management structure that provides enough level of abstraction to manage a centralized search in complex media creation environment (i.e., across different external databases);
A mechanism that will allow loosely coupled interfacing with a third party or legacy system (e.g., using standard email communication);
A Centralized monitoring solution to manage consolidation of alarms and logs of the technical and operational infrastructure; and
Collaborative tool(s) that leverage new methods like chat engines as well as legacy solutions such as an Intercom dedicated in broadcast environment with a voice over IP intercom at the desktop. By way of example, since the present system has the capability of tracking processes, knowledge exists about the users who are handling different tasks in the system. This allows the capability to see what the other users are doing and who is connected to the system. As a result, a chat solution becomes easy to implement to allow communication between the users.

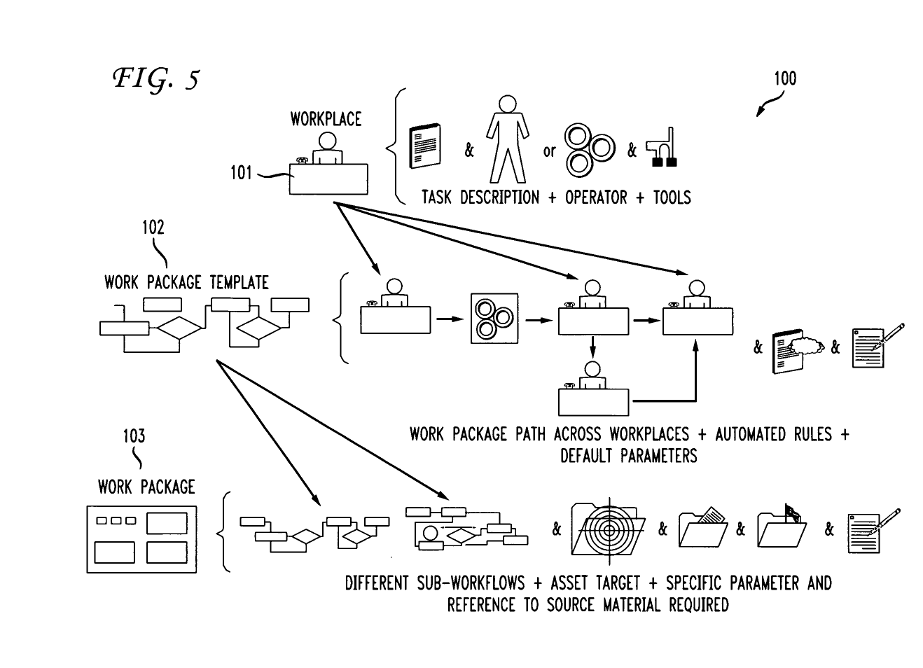

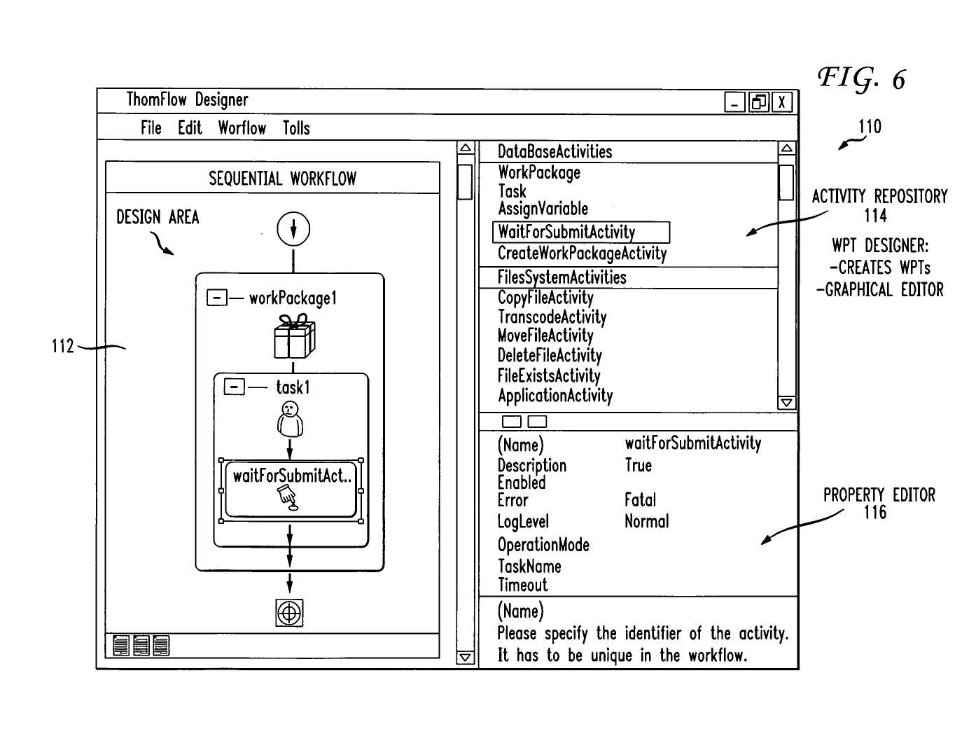

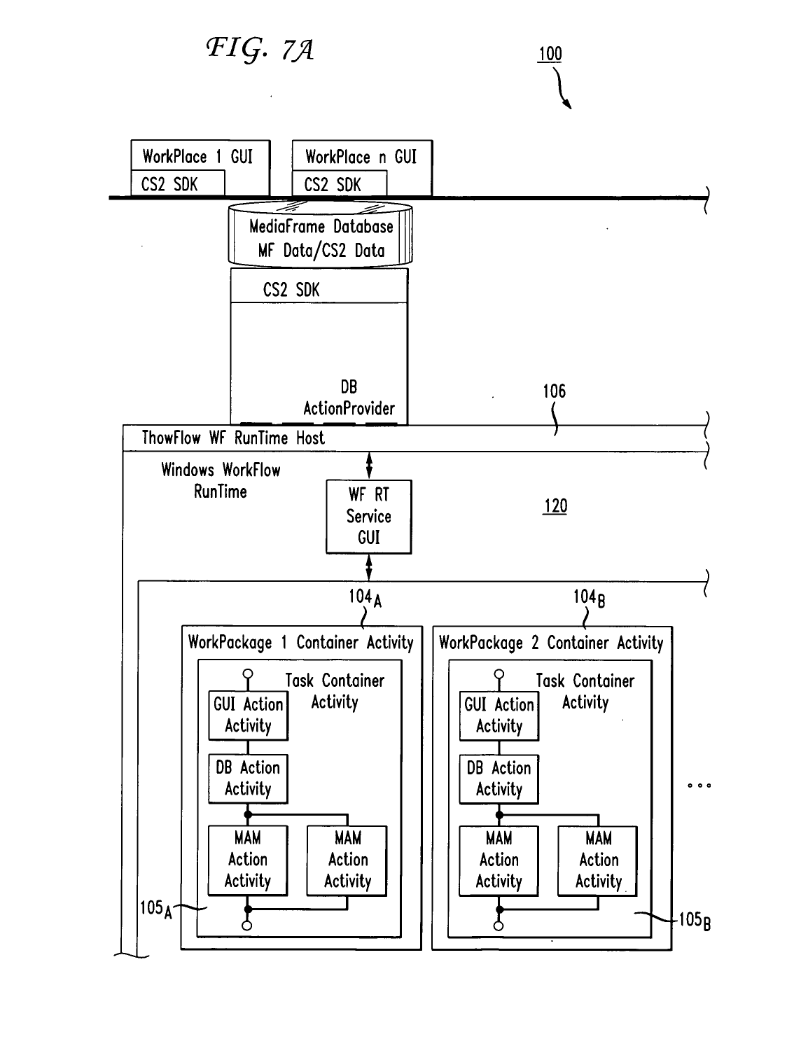

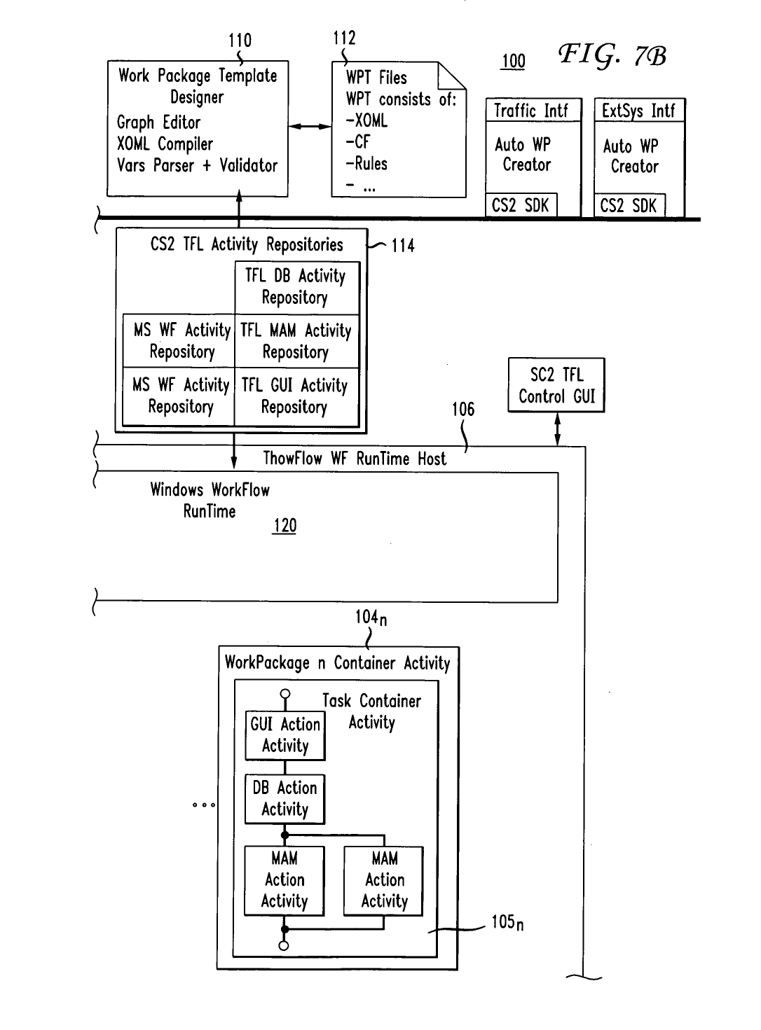

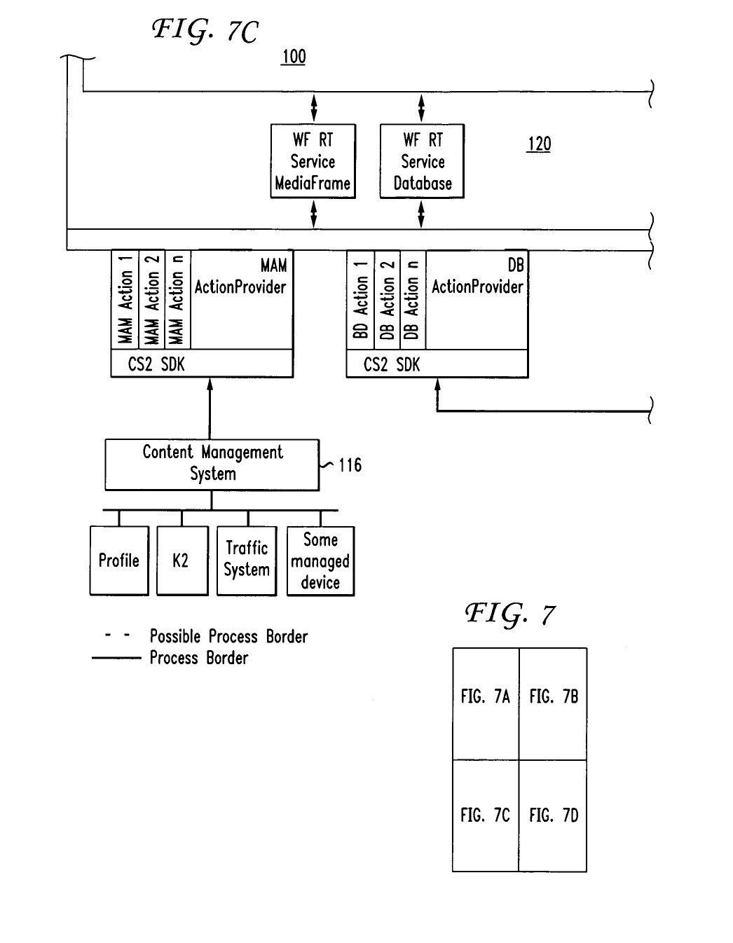

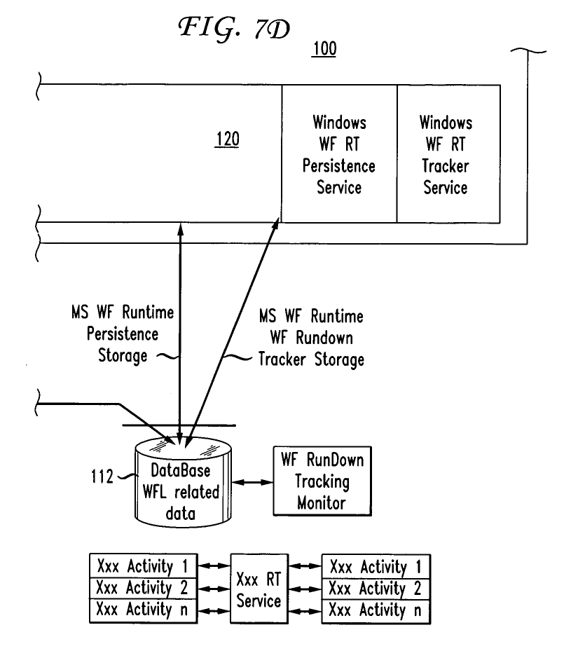

FIG. 5 depicts the Workflow Engine as core part of a Workflow Management System 100 that provides the means to automatically forward Work Orders as specific Tasks to specific Workplaces based on defined workflows. Elements of the Workflow engine 100 includes: the Work Package Template 102; the Work Package 104; the Work Package Template (WPT) Editor 110 shown in FIG. 6; and a System Database (not shown).

The Workplace 101 is made up of a task description, an identification of the operator for the particular task or group of tasks, and the requisite tools for the operator to perform the task or group of tasks. The Work Package template 102 is generally made up of the work package path across the Workplaces for the same, automated rules and default parameters. The Work package 104 generally includes the different sub-workflows, the asset target and specific parameters and references to source material required to perform the respective tasks.

Both the Work Order and the Workflow are aggregated into a Work Package Template 102, which will be created by using a graphical Work Package Template Editor based on requirements as outcome of a previously broadcast facility “real life” workflows analysis. The WPT Editor can be run offline and be imported into the system as a file when needed. Multiple Work Package Templates 102 can be managed in parallel, allowing the ability to deal with the different needs in the different areas of a broadcast facility.

Referring to FIG. 6, the WPT-Editor 110 supports Work Package Templates 102 both as files on the file-system and as records in the CS2 system database, thereby allowing the ability to create Work Package Templates in an offline mode and to store and retrieve WPTs to and from the CS System DB in on online mode. An Import/Export filter comprise part of the WPT-Editor 110. The Editor 110 provides means to both edit the workflow through the design area 112, while using graphical symbols representing Activities provided through an Activity Repository (Activities Gallery) 114, as well as the Work Order, while defining WFL-Variables for the domain specific Activities “Work Package” and “Task”. The WFL-variables are managed through the property editor 116. This concept allows a declarative description of a customer's workflows by systems engineer(s) without any further lower level programming task for software development engineers. This tool furthermore provides levels of plausibility checks for a Workflow, some already online during the edit process, others during the compilation process of the Workflow into executable code.

Both parts of the Work Package 104 and the Work Order, represented through WFL-Variables, and the Workflow, represented as compiled executable code, will be exported to the System Database 112 for further usage through the Workflow Engine 100. Because some of the WFL-Variables can have been defined in a way that they need actual values before they can be activated for run-down in the Workflow Engine, each of the WFL-Variables include attributes attached describing how the variables should be used.

### Declarative Programming and Activities

The Activities (contained in the activity repository), which are used by the graphical WPT-Editor 110, need to be defined and programmed before they can be used with the Workflow Engine 100. In this sense, these Activities represent not only the words but also the grammar of a “Declarative Programming Language”, which is formulated in XOML. The programming language provides standard activities (e.g. implementing workflow patterns) or providing control access to standard file systems, (e.g. NTFS, as well as broadcast specific activities), which are used to control underlying Content Management Systems 116 or process devices, e.g. Transcoders, directly.

All Activities provide a first part, which will be used to render the activity in the WPT-Editor 110, as well as a second part, which will be executed during run-time, while a Work Order shows up as tasks as designated Workplaces according to patterns applied to the related Workflow. In the WPT-Editor 110 all activities are provided in Activity Repositories (galleries) 114, which provide the Activities in a sorted manner. The Activities Concepts, which is a subset of a task, uses a framework to allow augmentation of the “vocabulary” of a “broadcast domain specific language” with new and/or enhanced functionality by describing a low level action at the device or workflow level. For example, we can create a new activity called “watermark” if we are connected to a subsystem that can handle watermarking.

The new activities are provided with the Workflow designer and the Workflow engine in as part of a new product version and can be used thereafter with the new Work Package Templates

The Workflow-Part of a Work Package 104 is modeled using the Activities, which represent either standard workflow patterns like OR Split/Join. Furthermore Activities are used to model the Work Package 104 itself as well as Tasks as parts of the Work Package, which are concatenated to a workflow using Workflow Pattern Activities. Task Activities are used to model the Workplaces, where Work Orders show up as Tasks according to the Workflow.

As mentioned above, “within” Tasks Action Activities will be used to model the actions, which provide the actual interfaces to the process environment, and “inside” Tasks Action Activities can be concatenated with Workflow Pattern Activities to model the workflow at this level. By way of example every entity in MS WFE is either MS Workflow or MS Workflow Activity. For CS2 the MS entities have been structured:

### TFL WP(T)=MS WFL.

TFL TASK=specific CS2 domain related MS Activity.
TFL Action=specific CS2 domain related MS Activity.
In other words,
A TFL WP(T) is a MS WFL and hose TFL tasks.
TFL Tasks are MS Activities and hosts TFL Actions.
TFL Actions area MS Activities and hose MS Activities.
At each level, standard MS flow control Activities will be used to combine the domain specific activities into a WFL.

The Workflow Engine 100 comes with a bundle of broadcast domain specific Action Activities enabling control of process devices of subsystems either using an underlying Content Management System or by controlling the devices of subsystems directly. Those of skill in the art will recognize that examples of such action activities can include, for example, Record clip, Archive Clip, Transcode Clip, Wrap MXF files, Embed Subtitle, Decode video, Multiplex audio track, Analyze file, Create video proxy, etc.

For the Workflow Pattern to provide conditional workflow execution, the evaluation of expressions and rules is required. The formulation of expressions and rules is done in a C# like style. WFL-Variables and Constants can be used for evaluation, providing the capability to control the execution of a workflow depending on process environment status. A simple example is a Workplace, where the next workplace within the group of all selectable Workplaces can be selected. Depending on the input, the Workflow Engine selects the desired path and forwards the Work Order to the next selected Workplace.

As a more complex example, a failure in one of n parallel paths, can be treated in a way that a repetition of the tasks in this specific branch can be executed a defined number of repetitions. If the expected result is not achievable after the number of defined repetitions, the Workflow (Engine) could select a path which sends an email to a configurable operator. After this action, the workflow engine 100 will let the branch join with the already executed parallel paths and the workflow can continue.

Manual and Automatic Work Package creation, Work Package Concatenation

The Workflow Engine 100 provides means to instantiate (“create”) Work Packages from previously designed Work Package Templates (stored in a database), which can be seen as “blue prints”, while combining actual process data for the Work Order with the “blue print” or template. This can be done either manually with operator interaction at specific Workplaces or automatically from an external system, while using an appropriate interface.

It is also possible to instantiate Work Packages from within an active Work Package, allowing the concatenation of Work Packages. Because it might be necessary to already provide values for some variable before Work Package Activation, the WFL-Variable attributes can be used to determine the usage of the Variables. This can be performed by simply calling to create a new Work Package as an action at the end of an active Work Package.

For systems as automated clients at the Workflow Engine 100, a WPT-Manifest will be created by the Work Package Template-Editor 110, describing what WFL-Variables need to be supplied with values. A list of automatically usable Work Package Templates as well as a Template Manifest for a selected Work Package Template can be retrieved from the Workflow Engine 100 using the appropriate interfaces, e.g. Web Services. The client can use the WPT Manifests as triggers to create and activate a Work Package in the Workflow Engine.

Workflow Control, Long Running Tasks, Thread process Agility

The Workflow Engine is designed to cope with workflow-management-specific “long running” tasks, while providing process and thread agility allowing the entire persistence of the status of the workflow for the time the workflow is waiting for response triggers from the process environment. In this environment one can never guarantee that the same thread, or the same process, or even the same machine is running, when the process environment signals the task ready status. Thus, the Workflow Engine 100 provides an infrastructure, which takes care of the persistence of the workflow in defined persistence storage, until the process environment signals task ready.

At any given moment, the Workflow Engine 100 receives the signal for a specific Work Package instance, the engine retrieves the Work Package instance from the persistence storage 112. According to the current status in the Workflow of the Work Package instance, the next workflow steps will be executed. Depending on the Action Activities used in a Task, it can be either executed totally automatic if only Process Control Action Activities are used or the Task is manual in case a User Interface Action Activity is used.

Manual Tasks show up at defined User Workplaces, where operators can do their work, which is defined in the Work Order for a specific Workplace. Automatic Tasks show up at “Automatic Workplaces”, where the status and the progress of automatically executed process control actions will be displayed. The Workflow Engine provides means to monitor the run-down of the Work Orders as part of an active Work Package and to get status information about the Workflow Engine and the controlled Work Packages within the Workflow Engine. Because the state of a Work Package will be persisted in the System Database 112, clients can use this information to display the current status of all Work Packages, which are currently active and thus under control of the Workflow Engine.

During run-down of the Work Order, the current execution times will be retained for each task in a Work Package. This information will be stored in the System Database 112 and can be taken by appropriate clients for facility process execution monitoring. Multiple Work Packages 104, where each can be the host of a different Workflow, can be executed simultaneously. A Priority Management concept allows assigning priorities to Work Packages. The Workflow Engine 100 organizes the activation and execution of the Work Packages 104 depending on the specific Work Package priority.

### Inter-Domain Operation

The Workflow Engine 100 is designed to control a defined logical area, which is called a Workflow Control Domain. Depending on the network infrastructure, the workplaces which belong to a Workflow Control Domain can be distributed to remote sites, however they belong logically to the same Workflow Control Domain. Inter-Domain operations, i.e. coupling Workflows between two independent Workflow Control Domains will be done with loosely coupled interfaces, represented by “Workflow Inter-Domain Control Workplaces”. In one Control Domain this Workplace shows up as a “normal” Workplace, providing tools for the specific task to inform a counter part in another Control Domain. The Message Channel between the two workplaces is not specified. For example, it can be an email system, a fax machine, a printer with “sneaker net”, etc. What is important is the concept of the “Workflow Inter-Domain Control Workplaces”, which is simply a workplace, providing the tools mentioned above where the workplace can be remotely located from the from the Workflow.

In a Workflow, this Workplace will be modeled where the control flow is defined to leave the local domain. The Workflow Engine uses the defined tools, while executing the automatic Tasks and Actions defined in the Workflow. These Actions prepare the defined message for the available message channel, sends the message, and simply waits for the response from the remotely located Workplace.

It is important to note, that the local “Workflow Inter-Domain Control Workplace” does not need to know what kind of Workflow Management System takes the trigger message and how this system executes its own workflows. Once the trigger message has been forwarded to the other system, this Workplace simply waits for the response from the corresponding Workplace according to the Workflow. This trigger message can be, for example, a simple email, with a return email received by the Workplace.

In environments, where some influence of the remote system is possible, a workplace application can be provided, which is more closely integrated with the “Workflow Inter-Domain Control Workplace”, allowing the remote tasks to show up automatically in a task in-tray. Staff members of the remote facility then can take care about the task and return the “task completion signal” once the task is done. In an environment where a Workflow Control Domain is set up as well, a closer interaction is foreseen. In the remote Domain a Workplace is defined, which can take the trigger message from the local Domain and create a local Work Package in the remote domain.

This Work Package in the remote domain executes the required and defined tasks according to the hosted workflow and returns the defined “Workflow completion signal”, while using its own “Workflow Inter-Domain Control Workplace”. This message triggers the waiting Work Order in the local domain and the local Workflow Engine continue with the workflow execution. This concept allows coupling the automated local workflow with a remote workflow, depending on the capability of the remote system.

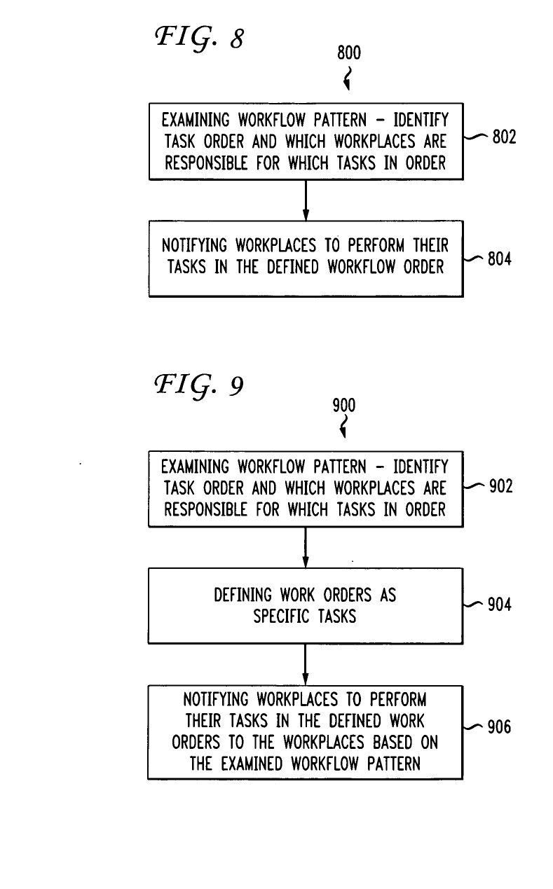

FIGS. 8 and 9 show high level flow diagrams 800 and 900, respectively, of a method for media production according to an illustrative embodiment of the present principles of the principles disclosed above. Referring to FIG. 8, initially the workflow pattern is examined (802) and the task order is identified along with which Workplaces are responsible for which tasks in a particular order. Once examined and identified, the Workplaces are notified (804) to perform their respective tasks according to the defined workflow order. Referring to FIG. 9, the initial stop 902 is the same as 802 in the examination of the workflow pattern and identification of the task order and Workplaces responsible. At this point, an additional step of defining Work Orders as specific tasks (904) can be performed to assist in the notification step (906) where the respective Workplaces are provided with their Work Orders as set forth by the Workflow pattern.

The illustrative embodiment of the present principles described herein can be implemented in, for example, a method or process, an apparatus, or a software program. Even if only discussed in the context of a single form of illustrative embodiment of the present principles (for example, discussed only as a method), the illustrative embodiment of the present principles of features discussed can also be implemented in other forms (for example, an apparatus or program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device.

Additionally, the methods can be implemented by instructions being performed by a processor, and such instructions can be stored on a processor-readable medium such as, for example, an integrated circuit, a software carrier or other storage device such as, for example, a hard disk, a compact diskette, a random access memory (“RAM”), or a read-only memory (“ROM”). The instructions can form an application program tangibly embodied on a processor-readable medium. As should be clear, a processor can include a processor-readable medium having, for example, instructions for carrying out a process. As should be evident to one of skill in the art, the illustrative embodiment of the present principles can also produce a signal formatted to carry information that can be, for example, stored or transmitted. The information can include, for example, instructions for performing a method, or data produced by one of the described embodiments. Such a signal can be formatted, for example, as an electromagnetic wave (for example, using a radio frequency portion of spectrum) or as a baseband signal. The formatting can include, for example, encoding a data stream, packetizing the encoded stream, and modulating a carrier with the packetized stream. The information that the signal carries can be, for example, analog or digital information. The signal can be transmitted over a variety of different wired or wireless links, as is known.

A number of illustrative embodiments have been described. Nevertheless, it will be understood that various modifications can be made. For example, elements of different illustrative embodiments can be combined, supplemented, modified, or removed to produce other embodiments. Additionally, one of ordinary skill will understand that other structures and processes can be substituted for those disclosed and the resulting embodiments will perform at least substantially the same function(s), in at least substantially the same way(s), to achieve at least substantially the same result(s) as the embodiments disclosed. Accordingly, these and other illustrative embodiment of the present principles are within the scope of the following claims.

1. A method comprising the steps of:
examining a Workflow pattern to identify task order and which Workplaces are responsible for which tasks within a given order; and
notifying Workplaces to perform their tasks in the given task order defined by the Workflow pattern.

2. The method of claim 1, further comprising:
defining Work Orders as specific tasks in a Workflow engine; and
wherein the notifying comprises sending the defined Work Orders to the Workplaces based on the examined Workflow pattern.

3. The method of claim 1, further comprising the step of forming a Work Package Template from at least one Work Order and the examined Workflow pattern.

4. The method of claim 3, further comprising the step of storing formed Work Package Templates for later use.

5. The method of claim 3, wherein the step of forming of a Work Package Template comprises:
identifying at least one Work Package path across at least one Workplace;
providing at least one of an automated rule and default parameter corresponding to at least one task to be performed.

6. The method of claim 1, wherein said notifying step comprises:
providing a task description to the workplace;
identifying an operator at the workplace to perform the task; and
providing at least one tool to the operator at the workplace to perform the described task.

7. The method of claim 3, further comprising the step of defining a Work Package with the Work Package Template.

8. The method of claim 7, wherein said step of defining of a Work Package comprises:
identifying at least one sub workflow within the workflow pattern;
identifying at least one asset target corresponding to a task to be performed; and
providing at least one of a specific parameter and reference to source material required by the operator to perform the task.

9. A computer program product comprising a computer useable medium having computer readable program code embodied thereon for use in a media production and distribution environment, the computer program product comprising:
program code for examining a Workflow pattern to identify task order and which Workplaces are responsible for which tasks within a given order; and
program code for notifying Workplaces to perform their tasks in the given task order defined by the Workflow pattern.

10. The computer program product according to claim 9, further comprising;
program code for defining Work Orders as specific tasks in a Workflow engine; and
program code for sending the defined work orders to Workplaces based on the defined Workflow pattern.

11. The computer program product according to claim 9, further comprising program code for forming a Work Package Template from at least one Work Order and the examined Workflow pattern.

12. The computer program product according to claim 11, further comprising program code for storing formed Work Package Templates for later use for similar or identical tasks.

13. The computer program product according to claim 11, wherein the program code for forming of a Work Package Template further comprises:
program code for identifying Work Package paths across one or more Workplaces;
program code for providing automated rules and default parameters corresponding to the task or tasks to be performed.

14. The computer program product according to claim 9, wherein said program code for notifying comprises:
program code for providing a task description to the workplace;
program code for identifying an operator at the workplace to perform the task; and
program code for providing tools to the operator at the workplace to perform the described task.

15. The computer program product according to claim 11, further comprising program code for defining a Work Package with the Work Package Template.

16. The computer program product according to claim 15, wherein said program code for defining of a Work Package further comprises:
program code for identifying sub workflows within the workflow pattern;
program code for identifying asset targets corresponding to tasks to be performed; and
program code for providing specific parameters and reference to source material required by the operator to perform the task.
